(19) United States
(12) Patent Application Publication
(10) Pub. No.: US 2017/0355509 A1
(43) Pub. Date: Dec. 14, 2017

(54) PRESSURE AUTO-ADJUSTING PACKAGE FOR HEATED FOOD

(71) Applicant: KUO HSIANG TZU, Taichung City (TW)

(72) Inventor: KUO HSIANG TZU, Taichung City (TW)

(21) Appl. No.: 15/688,849

(22) Filed: Aug. 28, 2017

Related U.S. Application Data
(62) Division of application No. 14/576,187, filed on Dec. 18, 2014.

(51) Int. Cl. B65D 81/34; B32B 7/06; B32B 27/32; B32B 15/20; B32B 27/34; B32B 7/14; B32B 27/30; B32B 7/12; B32B 3/02; B65D 51/16; B32B 29/00; B32B 27/08; B32B 27/10; B32B 15/08; B32B 3/26; B32B 27/36

(52) U.S. Cl. CPC B65D 81/3453; B32B 27/365; B32B 7/06; B32B 27/32; B32B 15/20; B32B 27/36; B32B 27/34; B32B 7/14; B32B 27/308; B32B 7/12; B32B 3/02; B65D 51/1638; B32B 29/002; B32B 27/08; B32B 27/10; B32B 15/08; B32B 27/306; B32B 3/266; B32B 27/302; B32B 2255/24; B32B 2307/31; B32B 2255/205; B32B 2439/70; B32B 2274/00; B32B 2255/12; B32B 2435/02; B32B 2307/518; B32B 2255/10

(57) ABSTRACT

In a pressure auto-adjusting package for a heated food and a composite membrane thereof, the composite membrane includes a first membrane coated with a partial release layer thereon in a predetermined width, a second membrane provided with a cutting line corresponding to the partial release layer, and a glue layer disposed between the first membrane and the second membrane to glue the first membrane and the second membrane together, the first membrane and the second membrane are pseudo-glued at the position of the partial release layer, the cutting line of the second membrane is disposed at a heat seal opening and extends to the accommodating space. The package has a pressure generated therein when being heated, the pressure enters into a pseudo-glued area between the second membrane and the first membrane from the cutting line to form a gap where the pressure is released to prevent explosion.

### CROSS-REFERENCE TO RELATED APPLICATION

This application is a divisional application of application Ser. No. 14/576,187 filed on Dec. 18, 2014. The entire disclosure is incorporated herein by reference.

### BACKGROUND

### 1. Technical Field

The technical field relates to a pressure auto-adjusting package for a heated food, particularly to a composite membrane of the package. The composite membrane can automatically adjust the pressure in the package.

### 2. Related Art

The conventional packing method of ordinary microwave food uses packing box and the top cover to pack the food. In order to comply with the sealability and the preservation condition, a thin membrane is usually used to seal on the outer surface of the package. The thin membrane needs to be removed or gashed when the package is heated, and the explosion due to the pressure generated during the heating process can be prevented. However, take the microwave food sold in supermarket and the shopping mall as example, when heating the microwave food, it is an inconvenient work no matter opening the packing box by removing or gashing the membrane. Besides, after the heating process is completed, the packing box still needs to be taped to seal the opening to prevent the food from coming out. Therefore, the conventional microwave packing boxes and packing bags are not easy to use, and taping the packing box for sealing purpose still cannot reach high clean standards. Thus, there are many kinds of package capable of being heated without removing the packing membrane. This kind of packing membrane can automatically release the pressure inside the package when the package is heated, so as to prevent explosion from happening.

The existing products have the following problems:

1. Even though the pressure generated during the heating process can be released, the sealability of the package will be no longer good enough, and the dust or other contaminants will easily enters into the package, which results in contamination and sanitation problem.
2. The manufacturing process of some kinds of membranes used for sealing is complicated, and so is the procedure of applying the membrane on the packing box.
3. Some packing membranes allege the pressure generated during the heating process can be automatically released, but actually the effect is mediocre.
4. Even though the packing thin membrane can be used in pressure auto-adjusting package, however, the exterior pressure of the vacuum package is larger than the interior pressure, which makes the pressure auto-adjusting package not being able to be vacuumed, and thus the packing thin membrane is not suitable to be used in the vacuum package either.
5. The printing ink of some packing membranes can be melted down to enter into the interior of the package during the heating process, and the food inside the package could be contaminated accordingly.

### BRIEF SUMMARY

One of the exemplary embodiments according to the present invention is to provide a pressure auto-adjusting package for a heated food and the composite membrane thereof to solve the aforementioned problems.

In one of the exemplary embodiments, a pressure auto-adjusting package for a heated food includes a box body and a composite membrane. The box body has a bottom and a periphery extending from a side of the bottom, an enclosure of the periphery forms an accommodating space, and an opening is formed on an inner side of a top of the periphery. The composite membrane is heat-sealed on a periphery of the box body to seal the opening, the composite membrane includes a first membrane, a second membrane, and a glue layer; the first membrane is coated with a partial release layer thereon in a predetermined width; the second membrane is provided with a cutting line corresponding to the partial release layer; the glue layer is disposed between the first membrane and the second membrane to glue the first membrane and the second membrane together. The first membrane and the second membrane are pseudo-glued at the position of the partial release layer, and the second membrane of the composite membrane is adjacently glued to the periphery of the box, and the cutting line of the second membrane is disposed at a heat seal opening and extends to the accommodating space. By using the partial release layer and the glue layer to glue the first membrane and the second membrane, the contaminants can be prevented from entering into the accommodating space when the composite membrane seals the packing box. When the package is heated to generate pressure in the accommodating space, a gap can be created between the first membrane and the second membrane at the position of the partial release layer to release the pressure. If no partial release layer and glue layer exist, the first membrane, the second membrane, and the box body are sequentially laminated and glued together when the composite membrane is hot pressing bonding to the box body, and the pressure caused by the heating cannot create a gap between the first membrane and the second membrane. Thus, the pressure cannot be released.

In one of the exemplary embodiments, the pressure auto-adjusting package for a heated food, wherein a top ring edge is provided on the periphery of the box body, and the composite membrane is heat sealed on the top ring edge.

In one of the exemplary embodiments, the pressure auto-adjusting package for a heated food includes a sealed membrane bag consisted of two membranes, the sealed membrane bag has an accommodating space and at least one heat seal opening, wherein as least one of the two membranes is a composite membrane, the composite membrane includes a first membrane, a second membrane, and a glue layer, the first membrane is coated with a partial release layer thereon in a predetermined width, the second membrane is provided with a cutting line corresponding to the partial release layer, the glue layer is disposed between the first membrane and the second membrane to glue the first membrane and the second membrane together, the first membrane and the second membrane are pseudo-glued at the position of the partial release layer. Wherein, the second membrane of the composite membrane is adjacent to the other one of the two membranes, and the cutting line of the second membrane is disposed at a heat seal opening and extends to the accommodating space. If no partial release layer and glue layer exist, the first membrane, the second membrane, and the box body are sequentially laminated and glued together when the composite membrane is hot pressing bonding to the other one of the two membranes, and the pressure caused by the heating cannot create a gap between the first membrane and the second membrane. Thus, the pressure cannot be released.

In one of the exemplary embodiments, a partial heat-melt adhesive layer is disposed between the partial release layer and the glue layer, and a width of the partial heat-melt adhesive layer is larger than or equal to a width of the partial release layer so as to cover the partial release layer to separate the partial release layer from the glue layer. By this arrangement, the air outside the package cannot enter into the accommodating space when the package is vacuumed because the partial heat-melt adhesive layer stops the effect that the partial release layer applying to the glue layer and the second membrane. On the other hand, when the package is heated to generated pressure, the partial heat-melt adhesive layer will lose stickiness due to the heating, and the pressure will create a gap between the first membrane and the second membrane at the position of the partial release layer, thereby releasing the pressure. Therefore, the composite membrane according to the present invention is suitable for using in a vacuum package with pressure auto-adjusting function for heated food.

In one of the exemplary embodiments, the pressure auto-adjusting package for a heated food, wherein a width of the partial release layer is larger than a width of the cutting line, and the width of the partial release layer is smaller than a width of the glue layer.

In one of the exemplary embodiments, the pressure auto-adjusting package for a heated food, wherein the first membrane is selected from a group of nylon, acrylic, polyester, polyester, polyethylene, polypropylene, polyamide, ethylene-styrene copolymer, cycio olefin, polyethylene terephthalate, ethylene vinyl alcohol, ethylene vinyl acetate, ionic macromolecular compound, polyethylene naphthatate, poly ether ether ketone, polysulfone, styrene acrylonitriles, polyimide, polyvinyl alcohol, polyacrylonitrile, polyurethane, polycarbonate, wax paper, macromolecular multilayer co-pressed extension membrane, synthetic paper, glassine paper, paper coated with macromolecule, paper, membrane consisted of aluminium foil, aluminium foil laminate film, PET membrane after electroplating, BOPP membrane, CPP membrane, or multilayer membrane consisted of at least two layers membrane material.

In one of the exemplary embodiments, the pressure auto-adjusting package for a heated food, wherein the second membrane is a single layer membrane consisted of a material selected from PP, ABS, CPP, LLDPE, and CMPS, or a multilayer membrane consisted of at least two single layer membranes.

One of the exemplary embodiments according to the present invention also provides a composite membrane as aforementioned in the food packages.

The advantages of one of the exemplary embodiments according to the present invention as follows:

1. Each one of the membranes or layers of the exemplary embodiment according to the present invention is simple in structure and easy to apply to the target, which is also convenient for manufacturing. When the composite membrane needs to be hot pressed to bond with the package, the existing ultrasonic hot press machine or the electrical hot press machine can be used, which is very convenient as well.
2. The sealability of the composite membrane of the exemplary embodiment according to the present invention is good. The pressure caused by the heating can be released with ease, and the composite membrane can be restored to the original sealed condition after the pressure is released.
3. The composite membrane of the exemplary embodiment according to the present invention uses the glue layer to glue the interior side of the first membrane to the second membrane so as to seal the printing ink on the interior side of the first membrane. Thus, even though the printing ink melts after the package being heated, the printing ink can be prevented to enter into the package to contaminate the food.
4. The composite membrane of the exemplary embodiment according to the present invention can not only be applied to the pressure auto-adjusting package for heated food, but also can be used in vacuum package with pressure auto-adjusting function. Thus, the composite membrane has a variety of application.

### BRIEF DESCRIPTION OF THE DRAWINGS

These and other features and advantages of the various embodiments disclosed herein will be better understood with respect to the following description and drawings, in which like numbers refer to like parts throughout, and in which:

FIG. 1 is an exploded view of a composite membrane according to an embodiment of the present invention;

FIG. 2 is a sectional view of FIG. 1;

FIG. 3 is a perspective schematic view of the coiled composite membrane shown in FIG. 1;

FIG. 4 is a sectional view of a composite membrane of another embodiment according to the present invention;

FIG. 5 is a perspective schematic view of the composite membranes shown in FIGS. 1-3 when used in a package;

FIG. 6a is a sectional view along the line 6a-6a of FIG. 5 showing a condition before heating;

FIG. 6b is another condition of FIG. 6a, showing a condition after heating;

FIG. 7a is a sectional view along the line 7a-7a of FIG. 6a;

FIG. 7b is a sectional view along the line 7b-7b of FIG. 6b;

FIG. 8 is a perspective schematic view of a composite membrane shown in FIG. 4 when used in a package;

FIG. 9a is a sectional view along the line 9a-9a of FIG. 8 (before heating);

FIG. 9b is another condition of FIG. 9a (after heating);

FIG. 10a is a sectional view along the line 10a-10a of FIG. 9a; and

FIG. 10b is a sectional view along the line 10b-10b of FIG. 9b

### DETAILED DESCRIPTION

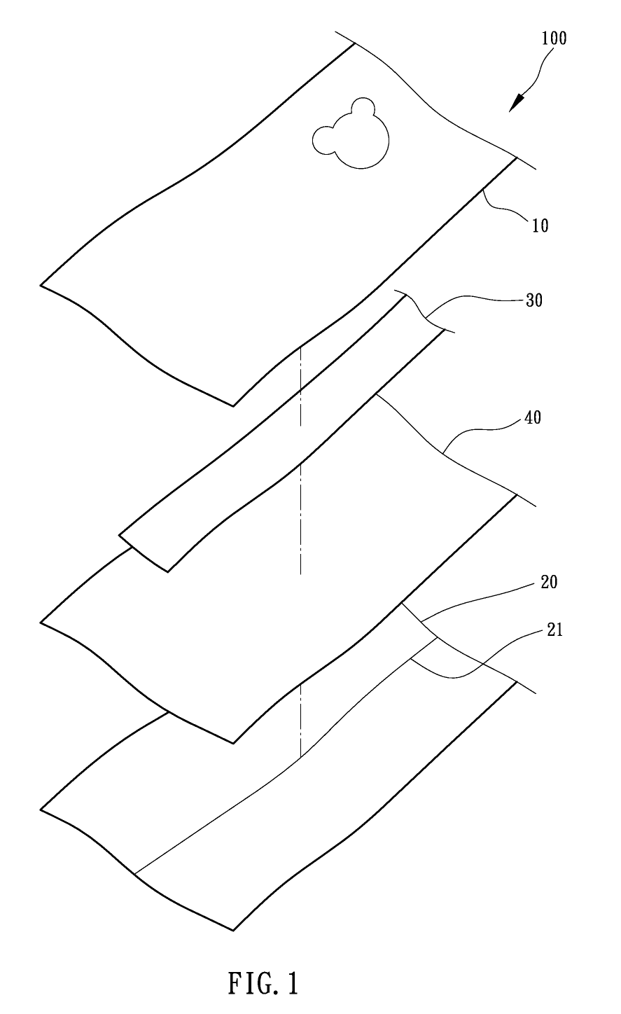

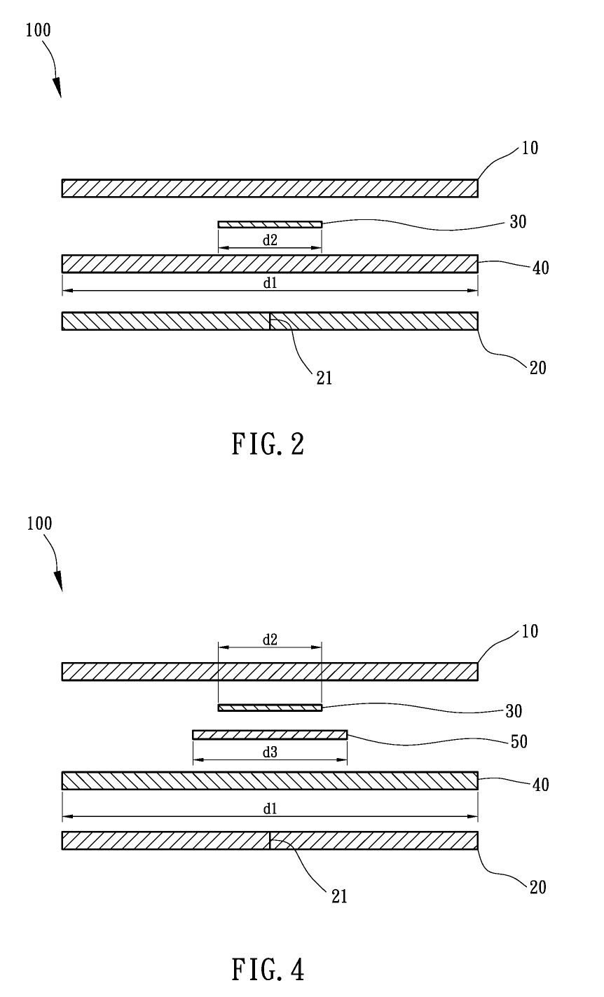

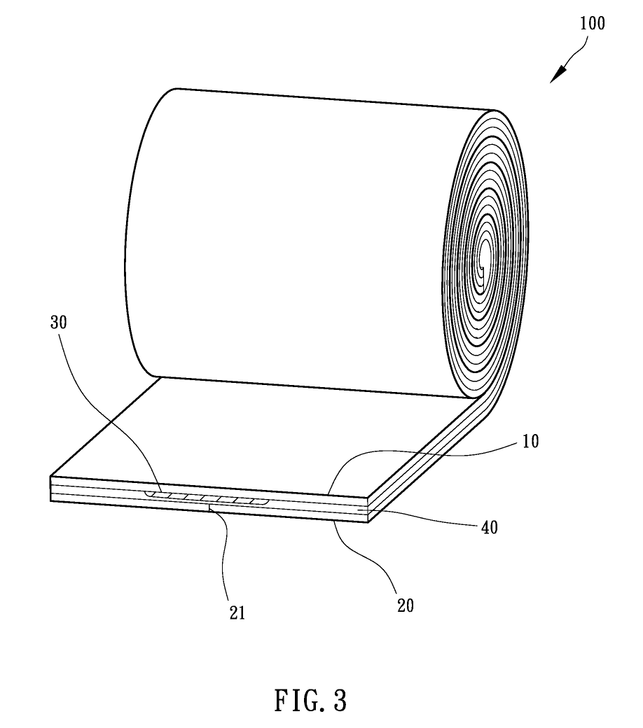

Referring to FIGS. 1-3, one of the preferred embodiments of the present invention provides a composite membrane 100 for a pressure auto-adjusting package for heated food. The composite membrane 100 includes a first membrane 10, a second membrane 20, a partial release layer 30, and a glue layer 40.

In one of the preferred embodiments of the present invention, the first membrane 10 is coated with a partial release layer 30 thereon in a predetermined width. The partial release layer 30 is a typical release agent. The first membrane 10 is selected from a group of nylon, acrylic, polyester, polyester, polyethylene, polypropylene, polyamide, ethylene-styrene copolymer, cycio olefin, polyethylene terephthalate, ethylene vinyl alcohol, ethylene vinyl acetate, ionic macromolecular compound, polyethylene naphthatate, poly ether ether ketone, polysulfone, styrene acrylonitriles, polyimide, polyvinyl alcohol, polyacrylonitrile, polyurethane, polycarbonate, wax paper, macromolecular multilayer co-pressed extension membrane, synthetic paper, glassine paper, paper coated with macromolecule, paper, membrane consisted of aluminium foil, aluminium foil laminate film, PET membrane after electroplating, BOPP membrane, CPP membrane, or multilayer membrane consisted of at least two layers membrane material. Besides, an inner side of the first membrane 10 is provided for printing, and the printed material can be seen from the outside, such as words, patterns, or symbols, which can be used as an indicator, an illustration, a trademark, or ornamentation.

In one of the preferred embodiment, the second membrane 20 is provided with a cutting line 21 corresponding to the partial release layer 30. The cutting line 21 means longitudinally cut the second membrane 20, and the cutting can be partial or whole. The figures shown in the present invention illustrate a whole cut. The material of the second membrane 20 is the same as the package itself, or some materials suitable for melting and bonding, such as a single layer membrane consisted of a material selected from PP, ABS, CPP, LLDPE, and CMPS, or a multilayer membrane consisted of at least two single layer membranes.

In one preferred embodiment of the present invention, the glue layer 40 is disposed between the first membrane 10 and the second membrane 20 to glue the first membrane 10 and the second membrane 20 together. The glue layer 40 is coated on the first membrane 10 having the partial release layer 30 disposed thereon. Therefore, the first membrane 10 and the second membrane 20 are pseudo-glued at the position of the partial release layer 30. Besides, the glue layer 40 not only glues the first membrane 10 and the second membrane 20 together, but also prevents the melted ink printed on the inner side of the first membrane 10 from entering into the package after the package is heated.

In one preferred embodiment of the present invention, a width d2 of the partial release layer 30 is larger than a width of the cutting line 21, and the width d2 of the partial release layer 30 is smaller than a width d1 of the glue layer 40.

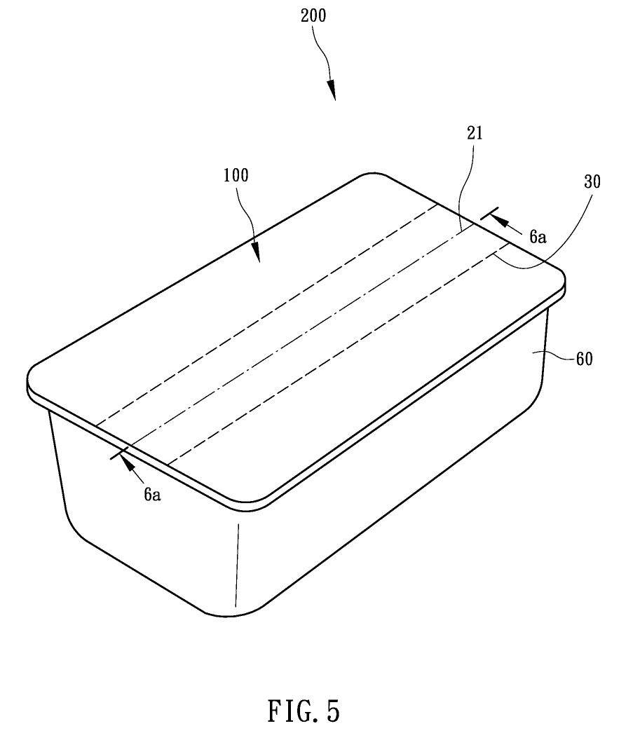

Referring to FIG. 4, in another preferred embodiment of the present invention, a partial heat-melt adhesive layer 50 is disposed between the partial release layer 30 and the glue layer 40, and a width d3 of the partial heat-melt adhesive layer 50 is larger than or equal to the width d2 of the partial release layer 30. In the present embodiment, the width d3 of the partial heat-melt adhesive layer 50 is larger than the width d2 of the partial release layer 30. Two sides of the partial heat-melt adhesive layer 50 are stuck to the first membrane 10. The partial heat-melt adhesive layer 50 is mainly used to separate the partial release layer 30 from the glue layer 40 to keep the partial release layer 30 not working under room temperature. When under the heating process, the heat can melt the partial heat-melt adhesive layer 50 so that the partial release layer 30 can start to work, and thus this design can be applied to a vacuum package with pressure auto-adjusting package for heated food.

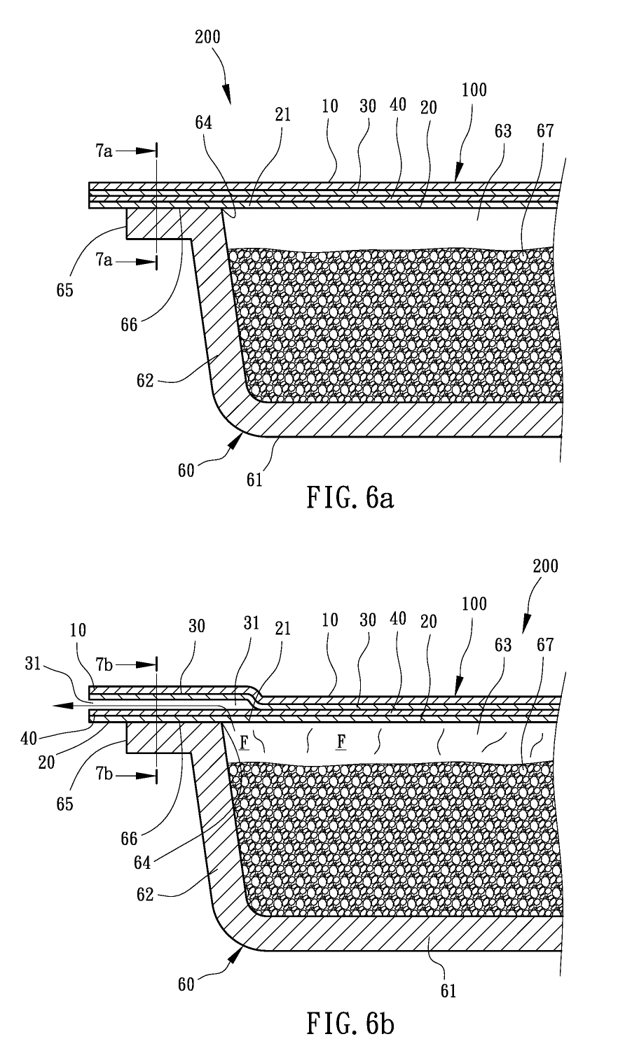

Referring to FIGS. 5-7b, an embodiment of the composite membrane 100 shown in FIGS. 1-3 used in the pressure auto-adjusting package 200 for heated food. The embodiment includes a box body 60 and the aforementioned composite membrane 100.

In one preferred embodiment of the present invention, the box body 60 has a bottom 61 and a periphery 62 extending from a side of the bottom 61. An enclosure of the periphery 62 forms an accommodating space 63 used for accommodating food 67. An opening 64 is formed on an inner side of a top of the periphery 62, and an outer side of the top of the periphery 62 extends to form a top ring edge 65. The composite membrane 100 is heat sealed on the top of the periphery 62, such as fixing to the top ring edge 65. The second membrane 20 of the composite membrane 100 is adjacently adhered to the top ring edge 65 of the periphery 62 of the box body 60, and the cutting line 21 of the second membrane 20 is disposed at a heat seal opening 66 and extends to the accommodating space 63.

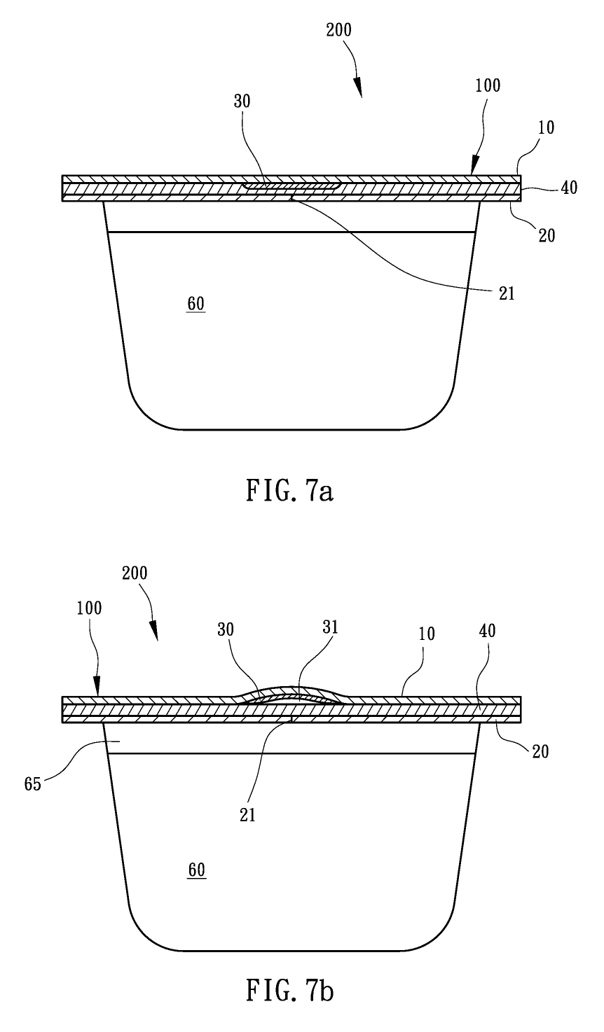

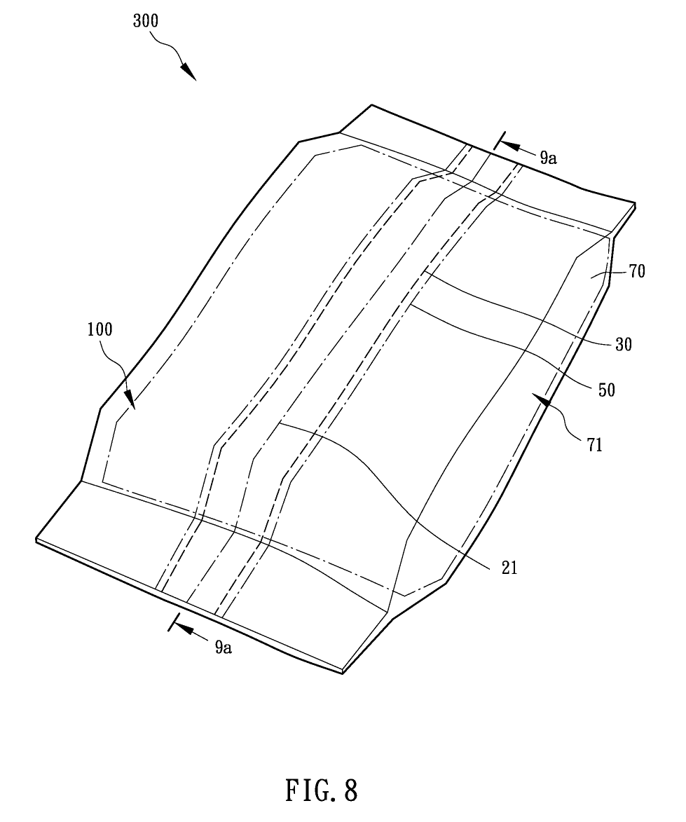

Referring to FIGS. 6b and 7b, when the pressure auto-adjusting package 200 for heated food is under the heating process, a pressure F will be generated in the accommodating space 63. The pressure F enters a space between the first membrane 10 and the second membrane 20 from the cutting line 21 of the second membrane 20 to create a gap 31 at a pseudo-glued position. The pressure F will be released from the gap 31. After the pressure F is fully released, the gap 31 will close to restore to the sealed condition to prevent contaminants from entering. If no partial release layer 30 and glue layer 40 exist, the first membrane 10, the second membrane 20, and the other one of the two membranes are sequentially laminated and glued together when the composite membrane 100 is hot pressing adhered to the other one of the two membranes, and the pressure F caused by the heating cannot create a gap 31 between the first membrane 10 and the second membrane 20. Thus, the pressure F cannot be released.

Besides, the composite membrane 100 shown in FIG. 4 can also be used in the package 200 of the present embodiment. Even though a partial heat-melt adhesive layer 50 is added, the main function of the composite membrane 100 is the same. The operating of the composite 100 will be illustrated below.

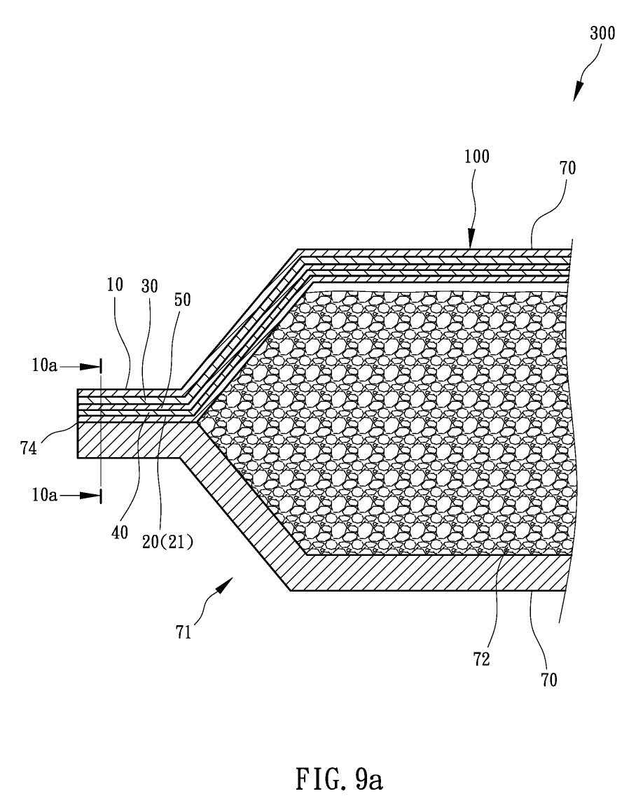

Referring to FIGS. 8 to 10b, a preferred embodiment of the composite membrane 100 shown in FIG. 4 when applied to the pressure auto-adjusting package 300 for heated food. The pressure auto-adjusting package 300 for a heated food includes a sealed membrane bag 71 consisted of two membranes 70, the sealed membrane bag 71 has an accommodating space 72 and at least one heat seal opening 74, and as least one of the two membranes 70 is a composite membrane 100. In the present embodiment, only one membrane 70 uses composite membrane 100, and the other one of the two membranes 70 can use the same composite membrane 100 or other kinds of membranes. The second membrane 20 of the composite membrane 100 is adjacent to the other one of the two membranes 70, and the cutting line 21 of the second membrane 20 is disposed at the position of the heat seal opening 74 and extends to the accommodating space 72.

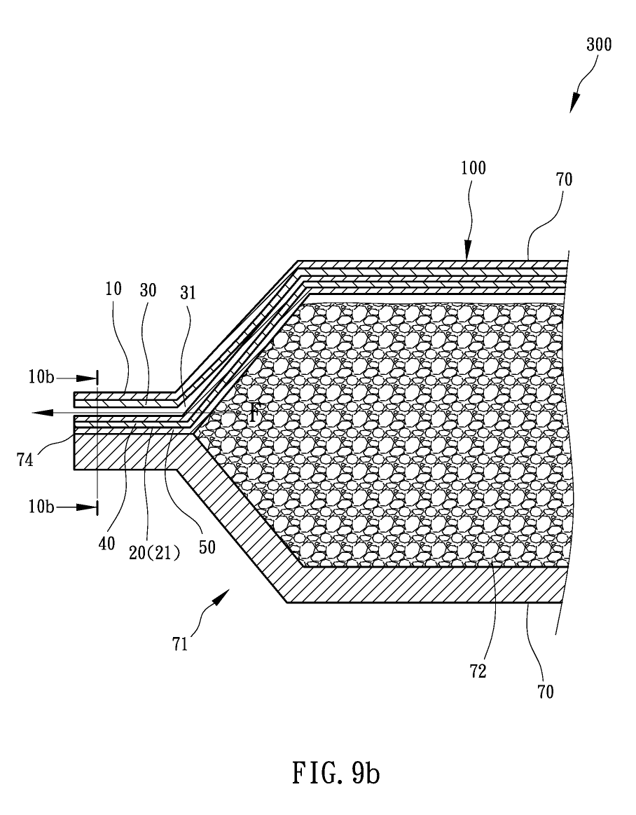

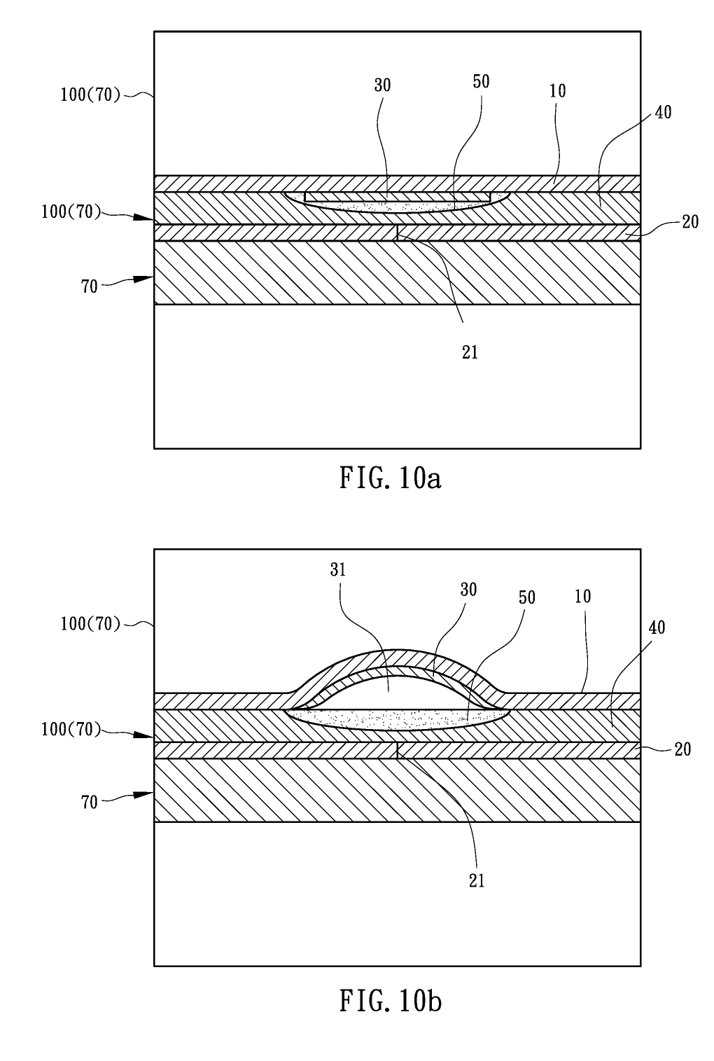

Referring to FIGS. 9b and 10b, when he pressure auto-adjusting package 300 for heated food is under the heating process, a pressure F and heat will be generated in the accommodating space 72. The heat will soften the partial heat-melt adhesive layer 50. The pressure F enters a space between the first membrane 10 and the second membrane 20 from the cutting line 21 of the second membrane 20 to create a gap 31 at a pseudo-glued position. The pressure F will be released from the gap 31. After the pressure F is fully released, the gap 31 will close to restore to the sealed condition, as shown in FIGS. 9a and 10a, to prevent contaminants from entering.

When the pressure auto-adjusting package 300 for heated food is under vacuuming before heating, the partial heat-melt adhesive layer 50 can temporarily stop the partial release layer 30 from working, and the outside air will not be able to enter the accommodating space 72 from the cutting line 21. Therefore, the composite membrane 100 according to the present invention can be used in vacuum and non-vacuum packages.

It should be noted that, the composite membrane 100 shown in FIGS. 1 to 3 can also be used as the membranes 70 of the pressure auto-adjusting package 300 for heated food, but the package 300 is not suitable for using in vacuum package.

Although the present invention has been described with reference to the foregoing preferred embodiments, it will be understood that the invention is not limited to the details thereof. Various equivalent variations and modifications can still occur to those skilled in this art in view of the teachings of the present invention. Thus, all such variations and equivalent modifications are also embraced within the scope of the invention as defined in the appended claims.

What is claimed is:

1. A pressure auto-adjusting package for a heated food, comprising:
a box body having a bottom and a periphery extending from a side of the bottom, an enclosure of the periphery forming an accommodating space, an opening being formed on an inner side of a top of the periphery; and
a composite membrane heat-sealed on a periphery of the box body to seal the opening, the composite membrane comprises a first membrane, a second membrane, and a glue layer, the first membrane being coated with a partial release layer thereon in a predetermined width, the second membrane being provided with a cutting line corresponding to the partial release layer, the glue layer being disposed between the first membrane and the second membrane to glue the first membrane and the second membrane together, the first membrane and the second membrane being pseudo-glued at the position of the partial release layer,
wherein the second membrane of the composite membrane is adjacently glued to the periphery of the box, and the cutting line of the second membrane is disposed at a heat seal opening and extends to the accommodating space.

2. The pressure auto-adjusting package according to claim 1, wherein a partial heat-melt adhesive layer is disposed between the partial release layer and the glue layer, and a width of the partial heat-melt adhesive layer is larger than or equal to a width of the partial release layer so as to cover the partial release layer to separate the partial release layer from the glue layer.

3. The pressure auto-adjusting package according to claim 1, wherein a width of the partial release layer is larger than a width of the cutting line, and the width of the partial release layer is smaller than a width of the glue layer.

4. The pressure auto-adjusting package according to claim 1, wherein the first membrane is selected from a group of nylon, acrylic, polyester, polyester, polyethylene, polypropylene, polyamide, ethylene-styrene copolymer, cycio olefin, polyethylene terephthalate, ethylene vinyl alcohol, ethylene vinyl acetate, ionic macromolecular compound, polyethylene naphthatate, poly ether ether ketone, polysulfone, styrene acrylonitriles, polyimide, polyvinyl alcohol, polyacrylonitrile, polyurethane, polycarbonate, wax paper, macromolecular multilayer co-pressed extension membrane, synthetic paper, glassine paper, paper coated with macromolecule, paper, membrane consisted of aluminium foil, aluminium foil laminate film, PET membrane after electroplating, BOPP membrane, CPP membrane, or multilayer membrane consisted of at least two layers membrane material.

5. The pressure auto-adjusting package according to claim 1, wherein the second membrane is a single layer membrane consisted of a material selected from PP, ABS, CPP, LLDPE, and CMPS, or a multilayer membrane consisted of at least two single layer membranes.

6. The pressure auto-adjusting package according to claim 1, wherein a top ring edge is provided on the periphery of the box body, and the composite membrane is heat sealed on the top ring edge.

7. A pressure auto-adjusting package for a heated food, comprising a sealed membrane bag consisted of two membranes, the sealed membrane bag having an accommodating space and at least one heat seal opening, wherein as least one of the two membranes is a composite membrane, the composite membrane comprises a first membrane, a second membrane, and a glue layer, the first membrane being coated with a partial release layer thereon in a predetermined width, the second membrane being provided with a cutting line corresponding to the partial release layer, the glue layer being disposed between the first membrane and the second membrane to glue the first membrane and the second membrane together, the first membrane and the second membrane being pseudo-glued at the position of the partial release layer,
wherein the second membrane of the composite membrane is adjacent to the other one of the two membranes, and the cutting line of the second membrane is disposed at a heat seal opening and extends to the accommodating space.

8. The pressure auto-adjusting package according to claim 7, wherein a partial heat-melt adhesive layer is disposed between the partial release layer and the glue layer, and a width of the partial heat-melt adhesive layer is larger than or equal to a width of the partial release layer so as to cover the partial release layer to separate the partial release layer from the glue layer.

9. The pressure auto-adjusting package according to claim 7, wherein a width of the partial release layer is larger than a width of the cutting line, and the width of the partial release layer is smaller than a width of the glue layer.

10. The pressure auto-adjusting package according to claim 7, wherein the first membrane is selected from a group of nylon, acrylic, polyester, polyester, polyethylene, polypropylene, polyamide, ethylene-styrene copolymer, cycio olefin, polyethylene terephthalate, ethylene vinyl alcohol, ethylene vinyl acetate, ionic macromolecular compound, polyethylene naphthatate, poly ether ether ketone, polysulfone, styrene acrylonitriles, polyimide, polyvinyl alcohol, polyacrylonitrile, polyurethane, polycarbonate, wax paper, macromolecular multilayer co-pressed extension membrane, synthetic paper, glassine paper, paper coated with macromolecule, paper, membrane consisted of aluminium foil, aluminium foil laminate film, PET membrane after electroplating, BOPP membrane, CPP membrane, or multilayer membrane consisted of at least two layers membrane material.

11. The pressure auto-adjusting package according to claim 7, wherein the second membrane is a single layer membrane consisted of a material selected from PP, ABS, CPP, LLDPE, and CMPS, or a multilayer membrane consisted of at least two single layer membranes.
